(19) United States
(12) Patent Application Publication
(10) Pub. No.: US 2015/0093733 A1
(43) Pub. Date: Apr. 2, 2015

(54) SOFTWARE PRODUCT USING GAMING PROTOCOLS AND TECHNOLOGY TO HELP PEOPLE DEAL WITH CHRONIC CONDITIONS

(71) Applicant: Litesprite, Inc., Bellevue, WA (US)

(72) Inventors: Swatee Surve, Bellevue, WA (US); Deven Smith, Bellevue, WA (US); Terry Nyguen, Bellevue, WA (US); Andrew Powell, Bellevue, WA (US); Ric Colgan, Bellevue, WA (US); Michele D'Amour McDanel, Bellevue, WA (US); Shawn Featherly, Bellevue, WA (US); Sean MacBean, Bellevue, WA (US); Samantha Artherholt, Bellevue, WA (US); Mukta Manavi, Bellevue, WA (US); Susan Williams, Bellevue, WA (US); Ryan Agnew, Bellevue, WA (US); Wanda Gregory, Bellevue, WA (US); Meagan Causey, Bellevue, WA (US); Michael Suryabudi, Bellevue, WA (US); Alok Sawant, Bellevue, WA (US); Amanda Skibiness, Bellevue, WA (US); Sylvia Chang, Bellevue, WA (US); Solon Scott, Bellevue, WA (US); Sandra Eisert, Bellevue, WA (US); Brad Tidwell, Bellevue, WA (US); Lauren Witt, Bellevue, WA (US); Siddarth Bhave, Bellevue, WA (US)

(21) Appl. No.: 14/504,177

(22) Filed: Oct. 1, 2014

Related U.S. Application Data
(60) Provisional application No. 61/885,140, filed on Oct. 1, 2013.

(51) Int. Cl. G09B 5/02

(52) U.S. Cl. CPC G09B 5/02
USPC 434/262

(57) ABSTRACT

A software product using gaming protocols and technology to help people deal with chronic conditions is described herein comprising four modules. The first module presents a therapeutic component to teach condition management skills. The second module presents a query component to assess various conditions. The third module presents an activities component to determine progress towards learning condition management skills. The fourth module presents a progression module to track that progress. Progress reports detailing the user's progress may be provided.

### BACKGROUND

1. Field of the Invention

The Invention relates to a type of amusement, recreation, or play activity commonly known as a game, wherein a player or participant engages in a competition or contest involving skill, ability, strategy, or chance, and whereby the ultimate outcome of the game can be determined or indicated according to a rule or rules.

2. Description of Related Prior Art

U.S. Pub. No. 20080146334 discloses MULTI-PLAYER ROLE-PLAYING LIFESTYLE-REWARDED HEALTH GAME. Embodiments of the invention disclosed in the '334 publication provide apparatuses, computer media, and methods for supporting lifestyle-rewarded health games, in which execution is altered based on the health behavior of the gaming participant. Input data indicative of the health behavior is obtained and converted into a gaming parameter. The gaming parameter is applied to the lifestyle-reward for the participant may be determined based on a utility function, and the reward parameter is invoked when the participant is playing the lifestyle-reward health game. Feedback to the participant may be incorporated during the execution of the lifestyle-reward health game, where the feedback is indicative of the participant's health behavior. An avatar may be depicted during the execution of the lifestyle-reward health game to illustrate the predicted health condition, in which the depiction is altered by changing the timeframe of the predicted health condition.

### BRIEF DESCRIPTION OF DRAWINGS

The detailed description set forth below references the following drawings, in which:

FIG. 1 is a first screenshot of an application or game according to an exemplary embodiment of a Main Menu;

FIG. 2 is a first screenshot of an application or game according to an exemplary embodiment of a Review Screen;

FIG. 3 is a first screenshot of an application or game according to an exemplary embodiment of a Description Screen;

FIG. 4 is a first screenshot of an application or game according to an exemplary embodiment of an in-game Animation;

FIG. 5 is a first screenshot of an application or game according to an exemplary embodiment of a Rate Screen;

FIG. 6 is a first screenshot of an application or game according to an exemplary embodiment of a Visualization;

FIG. 7 is a first screenshot of an application or game according to an exemplary embodiment of a Visualization;

FIG. 8 is a first screenshot of an application or game according to an exemplary embodiment of a Breathing Exercise;

FIG. 9 is a first screenshot of an application or game according to an exemplary embodiment of a Review Screen;

FIG. 10 is a first screenshot of an application or game according to an exemplary embodiment of a Questionnaire;

FIG. 11 is a first screenshot of an application or game according to an exemplary embodiment of a Questionnaire;

FIG. 12 is a first screenshot of an application or game according to an exemplary embodiment of a Questionnaire;

FIG. 13 is a first screenshot of an application or game according to an exemplary embodiment of an Affirmation Message;

FIG. 14 is a first screenshot of an application or game according to an exemplary embodiment of a Meditation Main Screen;

FIG. 15 is a first screenshot of an application or game according to an exemplary embodiment of a Meditation Breathing Exercise;

FIG. 16 is a first screenshot of an application or game according to an exemplary embodiment of a Meditation In-process Screen;

FIG. 17 is a first screenshot of an application or game according to an exemplary embodiment of a Meditation Word Exercise;

FIG. 18 is a first screenshot of an application or game according to an exemplary embodiment of a Meditation Painting View, with info;

FIG. 19 is a first screenshot of an application or game according to an exemplary embodiment of a Gallery Painting View, with info;

FIG. 20 is a first screenshot of an application or game according to an exemplary embodiment of a Fishing mini-game;

FIG. 21 is a first screenshot of an application or game according to an exemplary embodiment of a Fishing mini-game when is screen tapped;

FIG. 22 is a first screenshot of an application or game according to an exemplary embodiment of a Fishing mini-game when the fish starts to come to the top;

FIG. 23 is a first screenshot of an application or game according to an exemplary embodiment of a Fishing mini-game when the fish jumps out of the water;

FIG. 24 is a first screenshot of an application or game according to an exemplary embodiment of a Fishing mini-game where a boot comes out of the water;

FIG. 25 is a first screenshot of an application or game according to an exemplary embodiment of the inside of a Shrine;

FIG. 26 is a first screenshot of an application or game according to an exemplary embodiment of the inside of a Butterfly Walk mini-game;

FIG. 27 is a first screenshot of an application or game according to an exemplary embodiment of the inside of a Butterfly Walk mini-game;

FIG. 28 is a first screenshot of an application or game according to an exemplary embodiment of the inside of a Butterfly Walk mini-game;

FIG. 29 is a first screenshot of an application or game according to an exemplary embodiment of a generated report;

FIG. 30 is a first screenshot of an application or game according to an exemplary embodiment of a generated report;

FIG. 31 is a first screenshot of an application or game according to an exemplary embodiment of a generated report;

FIG. 32 is a diagram of an application or game according to an exemplary embodiment of a Main Menu;

FIG. 33 is a diagram of an application or game according to an exemplary embodiment of a therapy exercise that has been called “Journal of Clarity”;

FIG. 34 is a diagram of an application or game according to an exemplary embodiment of a component that clinicians can poll an individual player or a group of players that has been called “Oracle of Truth”;

FIG. 35 is a diagram of an application or game according to an exemplary embodiment of a mini-game component that teaches meditation that has been called “Meditation”; and

FIG. 36 illustrates an environment in which various embodiments can be implemented.

### DETAILED DESCRIPTION OF AN EXEMPLARY EMBODIMENT

FIG. 1 is the main screen shot of the exemplary application or game for treating one or more related conditions. As used herein, the term “related conditions” may include psychological conditions, physiological conditions, or other such secondary medical conditions that may be associated with a chronic medical condition. For example, a patient with a chronic medical condition of diabetes, cancer, asthma may also have a related condition such as depression. Similarly, a patient with a chronic medical condition of diabetes may also have a related physiological condition of increased tiredness after a meal. Chronic medical conditions (also referred to herein as “chronic conditions”) may include, but may not be limited to, cancer, diabetes, or asthma. Physiological conditions may include, but may not be limited to, fatigue, sleeplessness, or shortness of breath. Psychological conditions may include, but may not be limited to, depression, anxiety, stress, post-traumatic stress disorder, or post-partum depression. As may be contemplated, the examples of related conditions described herein are merely illustrative examples and other such types of related conditions may be considered as within the scope of the present disclosure. The exemplary application described herein may be used independently (i.e., in a standalone manner) or in connection with a treatment plan, which is a set of steps recommended by a health professional that may include a therapist, doctor, nurse, or a nurse practitioner.

The exemplary system is modular and has four components (also referred to herein as a “modules”) with executable instructions, which are a series of steps that, when executed, may cause a computer system to perform operations associated with each of the modules. The first component (or module) is a therapy component, which in the exemplary embodiment is defined as the “Journal of Clarity.” For other chronic conditions, the component may be something else, but in general there is a therapy component.

The second component is a component where a clinician can customize questions and directly poll an individual player (also referred to herein as “patient” or “user”) or group of players and is defined as the “Oracle of Truth.” For other chronic conditions, the component may be something else, but in general there is a component where a clinician can customize questions and directly poll an individual player or group of players.

The application includes a third component, which is referred to as a series of mini-games (also referred to herein as “activity module”). These mini-games are games that the user/player plays for distraction, relaxation, or reinforcement of activities that help managing a chronic condition, such as meditation, creating art or poetry, or going for a walk. For other chronic conditions, the mini-games may be something else, but in general there will be a mini-game component. Progress of activities may be tracked by activity metrics within the activity module.

The fourth component is defined as “Sock's Shrine” and is an exemplary embodiment of player progression (also referred to herein as “progression module”). For other chronic conditions, the component may be something else, but in general there is player progression with a progression goal, which is an end result that a player may be actively achieving. The progression goal may be tracked using progression metrics, which are a series of criteria that measures change.

The character “Socks the Fox” (also referred to herein as “Socks”) is a digital guide/pet that may be configured with a set of behaviors, which is a set of actions that the avatar may perform. Players may interact with a visual representation of the avatar, which is the graphics associated with the avatar. Players categorize their daily concerns and entrust Socks to “hold” their concerns while also engaging in other activities via the mini-games. By allowing Socks to help with their anxiety, the player helps Socks reach its goal, which is achieving an end result. Through interacting with the four components above, the player builds a strong emotional bond with the pet/guide. In other embodiments, for other chronic conditions, the character may be something else or may be absent. In an embodiment, audio can be played through the experience.

### Journal of Clarity

In the exemplary embodiment, a first component is “Journal of Clarity.” This is the therapeutic component that teaches chronic condition management skills, provides an immediate place to practice those skills, and an opportunity to bond with the character.

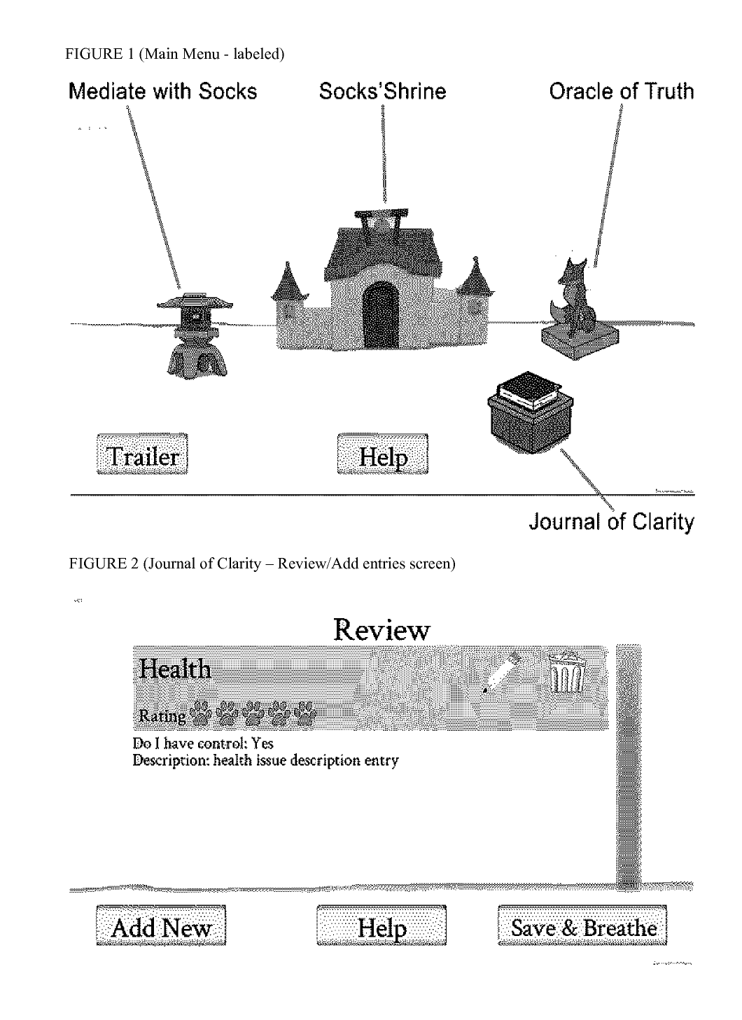

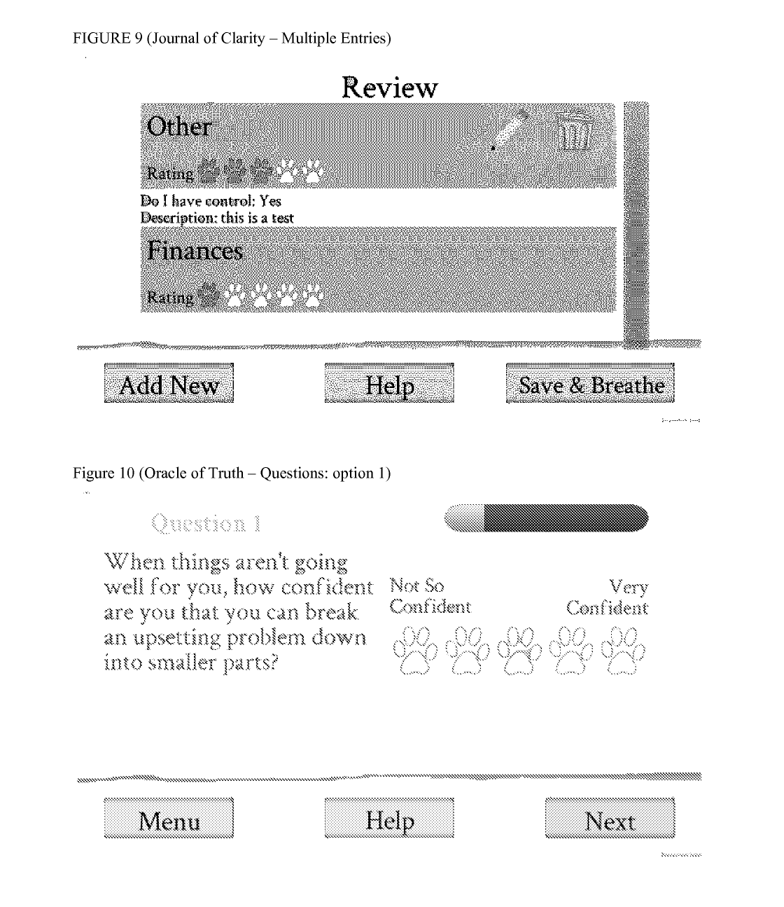

In the exemplary embodiment, the user will be directed through the screen shots shown on FIG. 2 after selecting the “Journal of Clarity” option shown in FIG. 1. FIG. 2, is a dashboard of the player's previously entered stress-inducing circumstances (i.e., an event that causes an individual stress). The player has an opportunity to submit particular stress-inducing circumstances. In this example, the user has previously submitted his/her health as a source of stress. The entry of this stress-inducing circumstance will now be described. The first time the user uses the system, there will be no stress-inducing circumstances listed. FIG. 9 is another example of the appearance of screen visible to the user and has the same function of FIG. 2. In the example associated with FIG. 9, the user has previously added stress-inducing circumstances within the categories of “Finances” and “Other.”

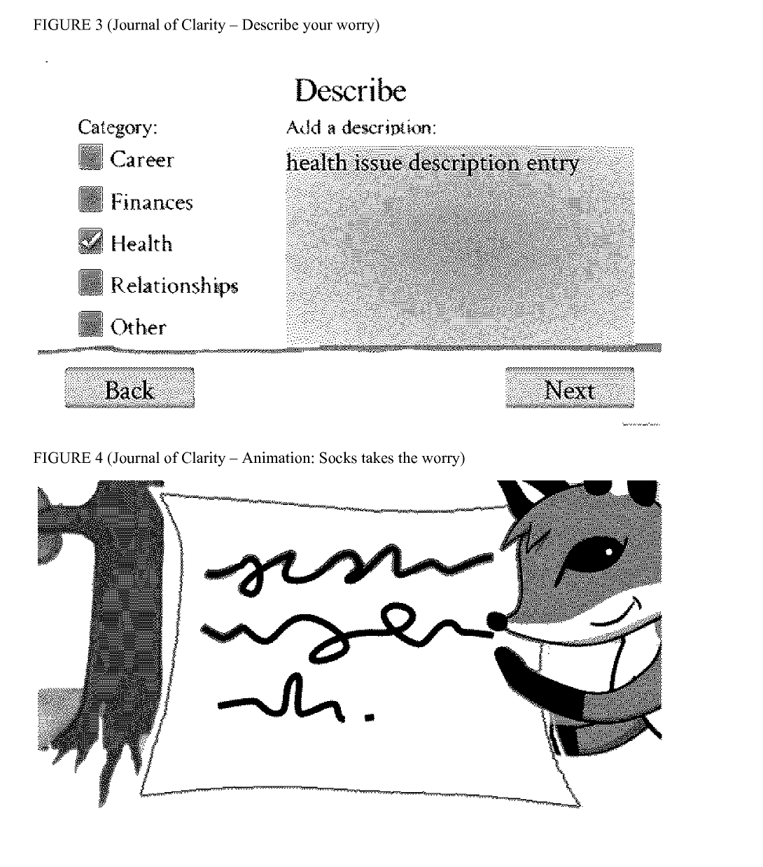

In FIG. 2, when the user selects the “Add New” option the screen shown in FIG. 3 is presented. The system can present the user with broad categories of stress-inducing circumstances. The system can also present the user with an “Other” so that the user can select the name of the stress-inducing circumstance. The textbox in FIG. 3 can be used by the user to add further details associated with the stress-inducing circumstance. These details can be accessed in FIG. 2 by an expanding menu associated with the dashboard of the stress-inducing circumstance.

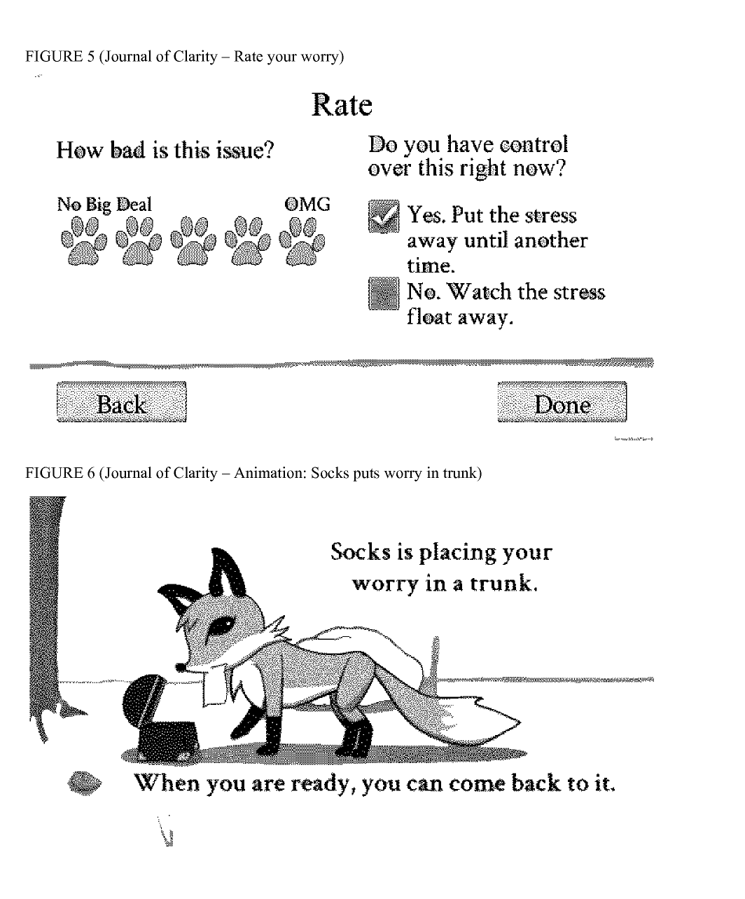

After selecting or naming the stress-inducing circumstance, an animation is displayed as shown in FIG. 4. It may include a sequence in which a note is dominant and the name of the stress-inducing circumstance is visible on the note. The note can then shrink in size and Socks will grasp the note. Then the system can allow the user to rate the level of stress caused by this stress-inducing circumstance, as shown in FIG. 5. In the exemplary embodiment, the level of stress is represented as a rating being a number of paws. FIG. 5 also shows that the system can allow the user to characterize the level of control the user has over the stress-inducing circumstance. In the exemplary embodiment, the stress-inducing circumstance can be characterized as controllable by the user or not controllable.

If the user selects the stress-inducing circumstance as controllable, the system can display a first animation. One screen shot of the first animation is provided in FIG. 6. The stress-inducing circumstance is visualized as a note in the character's mouth in FIG. 6. In this example, the note is taken in the mouth of the character. The animation can continue with the character placing the note within a trunk. Text is displayed on the screen that describes what is happening on the animation. Additional visualizations can be randomly shown from a set of visualizations or can be preselected by the player.

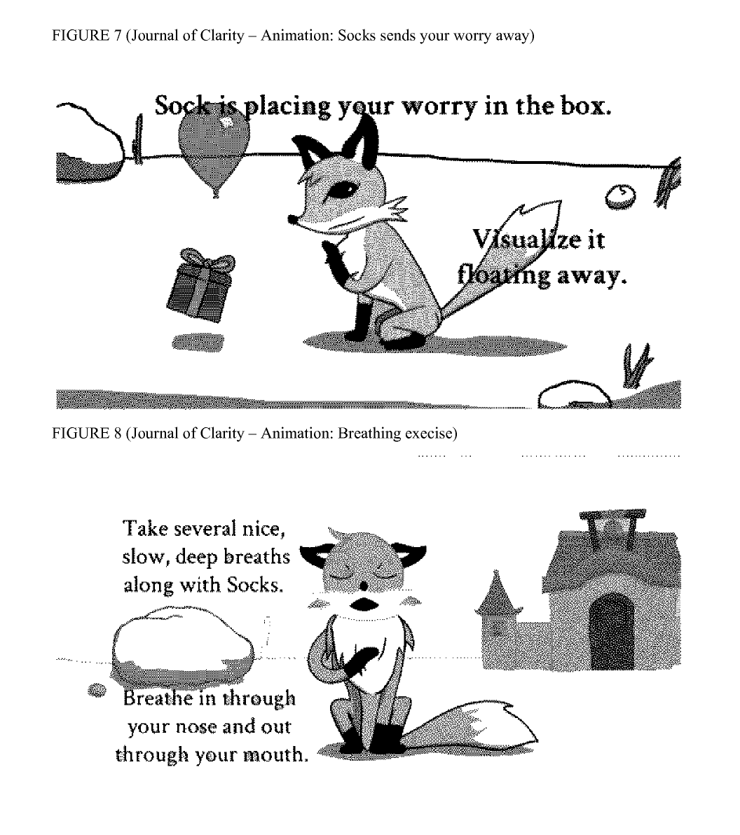

If the user selects the stress-inducing circumstance as not controllable, the system can display a second animation. One screen shot of the second animation is provided in FIG. 7. The second animation can include images of the box floating away. Text is displayed on the screen that describes what is happening on the animation. Additional visualizations can be randomly shown from a set of visualizations or can be preselected by the player.

After displaying one of the first or second animations to the user, the system can return to the screen shown in FIG. 2. As shown, another option available to the user is to delete any stress-inducing circumstance. For example, the dashboard of each stress-inducing circumstance includes a trashcan icon to accomplish deletion. The user can also edit the data associated with a stress-inducing circumstance. For example, the dashboard of each stress-inducing circumstance includes a pencil icon to accomplish editing.

After additions and modifications and review of stress-inducing circumstances, the user can select the “Save & Breathe” option. A third animation is displayed, guiding the user through a breathing exercise. One screen shot of the second animation is provided in FIG. 8. Text is displayed on the screen that describes what the player should do. It is noted that audio instructions can also be provided, with or without text on the screen. After the breathing exercises, the system again displays the main screen shown in FIG. 1.

### Oracle of Truth

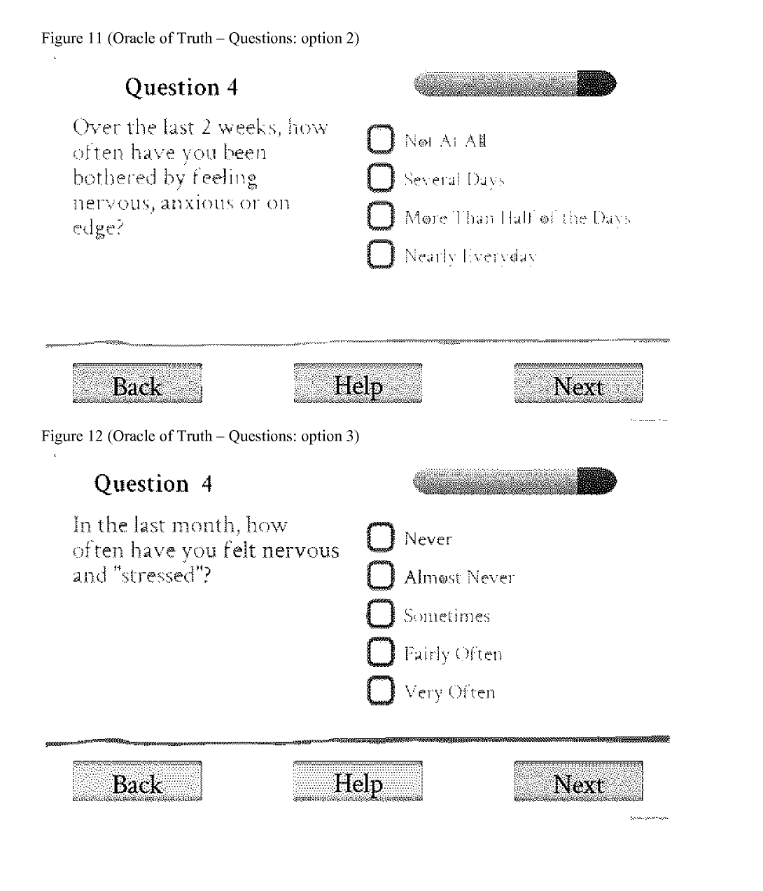

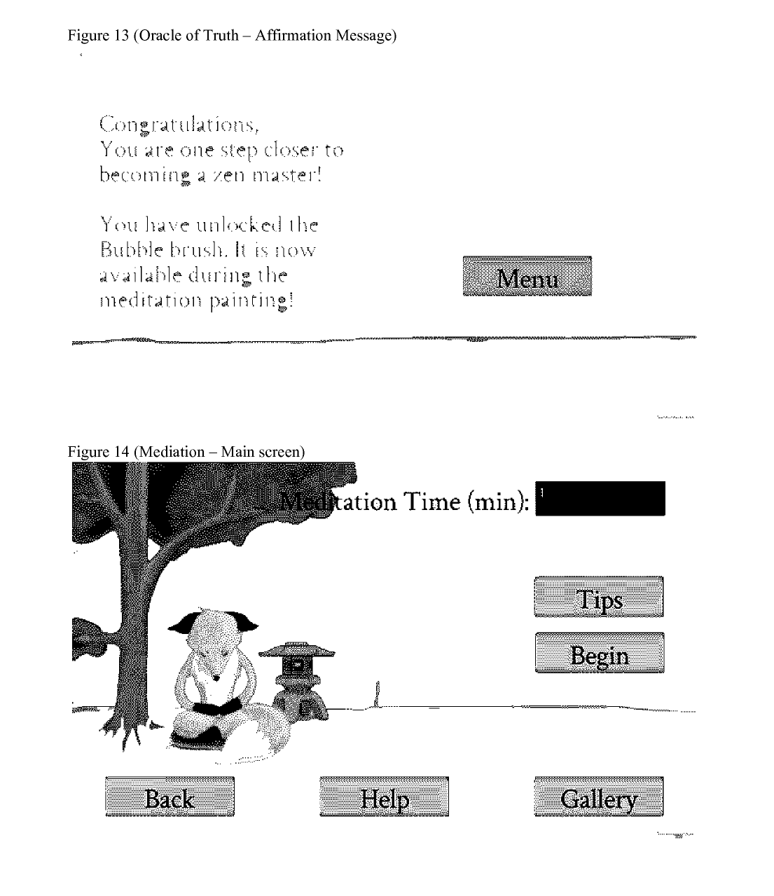

Another option for the user from the main screen in FIG. 1 is “Oracle of Truth.” This component enables questions to be asked directly to players (also referred to herein as “query module”). This is where clinicians, payers, providers, or community health organizations can present pre-set or customized questions to individuals or specific populations. When the player selects the “Oracle of Truth” on FIG. 1, the player will then be directed to the screen shown on FIG. 10. The player is subjected to a series of questions, such as the five questions that are sequentially displayed on FIGS. 10-12. In other embodiments, more questions could be posed. The questions posed could be selected from a pool of possible questions or custom questions. The questions can be selected randomly or selected in response to the application of an algorithm. The questions can be multiple choice questions or rating questions to minimize the ease of responding and also to render the responses to the questions as objective as possible for further data processing. A progress bar can inform the player of progress through the questions. In some embodiments, the user could be offered an exit option with each question so that the user can selectively end this part of the system at any time. When the player is done answering the questions, the player is directed to FIG. 13 for positive affirmation and then back to the main menu shown in FIG. 1.

Completion of the Oracle questions in a weekly basis will award the player with a random selection of a new painting brush to be used in the Meditation Paintings. A message indicating that a new brush has been awarded is seen in FIG. 13.

### Meditation Mini-game

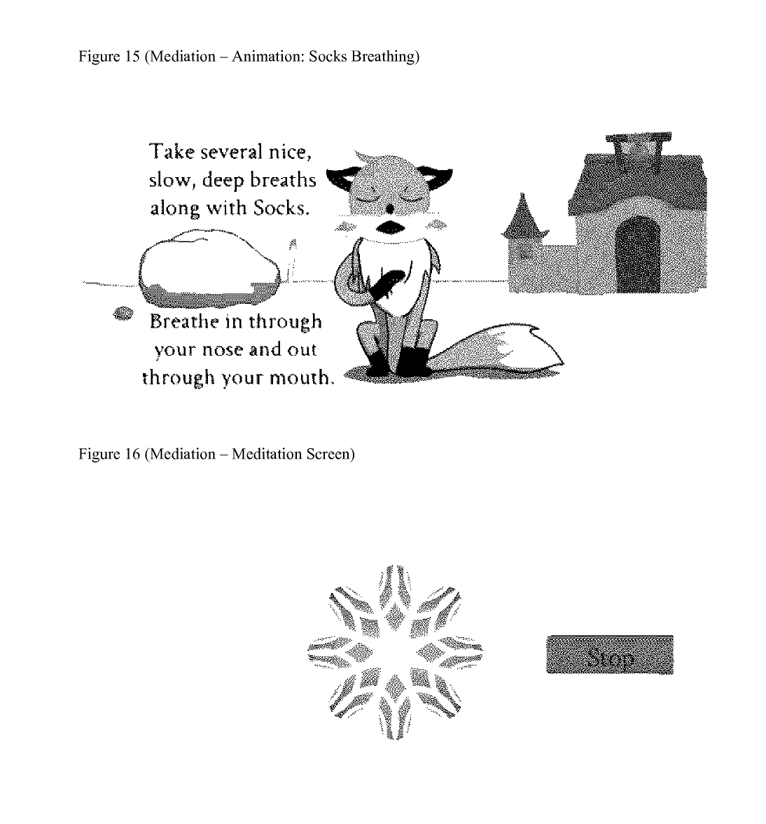

Another option for the user from the main screen in FIG. 1 is “Meditate with Socks.” This is a mini-game (also referred to herein as “meditation activities”) assists and educates the player/user with regards to the fundamentals of meditation. When the player selects “Meditate with Socks” from the main menu in FIG. 1, they are directed to the screen shown in FIG. 14. Here the player can configure the length of mediation and review basic tips for meditating. Once the player is ready to meditate, they can select “Begin” from the screen shown in FIG. 14. A short breathing animation is shown to help prepare the player for meditation. One screen shot of the second animation is provided in FIG. 15.

The actual meditation display is shown in FIG. 16. This display is dimmed in order to remove distractions from the players view. A Mandala image is displayed to aid in centering the players focus, and a rhythmic movement can set a pace for breathing and timing. Gentle ambient sounds/tones are played during the meditation session. The image displayed, sounds, volume, and movement patterns can be controlled through configurations. A stop button is displayed to end the meditation session early. If the player completes the planned session, they are given the opportunity to create a visual “painting” representing their session.

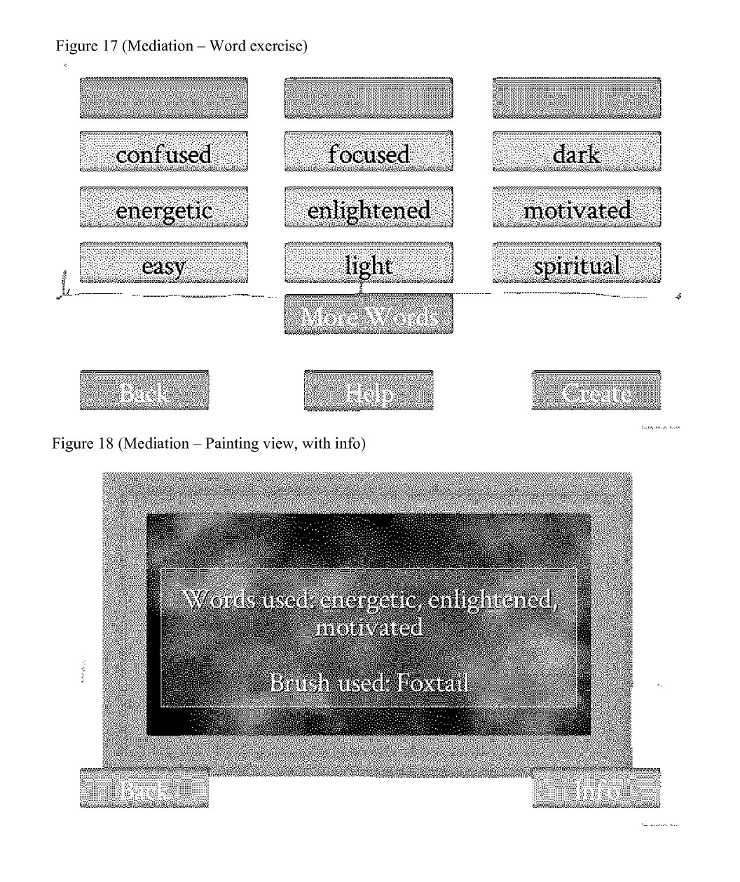

A word selection screen is displayed at the end of the timed meditation session. The word selection screen is shown in FIG. 17. These words are randomly arranged from a larger pool allowing the user to perform a word-association exercise with their current mood. The Player can select 1-3 words matching their mood. More words can be displayed by selecting the “More Words” button. Once the player has selected their words, they can click “Create” to create the visualized painting.

The Painting screen is displayed in FIG. 18. The panting is generated using a programmatic evaluation of the Words (Evaluated as colors), Time (evaluated as image density), and a random brush selected from the brushes earned by weekly activity in the Oracle of Truth. The user can show/hide information about the painting by clicking the “Info” button while viewing the painting. Clicking the “Back” button will return the player to the main Meditation screen as seen if FIG. 14.

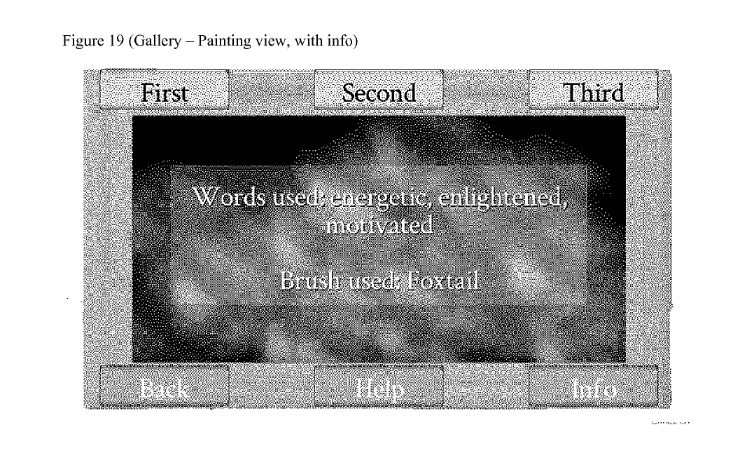

If the player wishes to review previous paintings, they can click the “Gallery” button in the meditation screen shown in FIG. 14. Clicking the gallery button will display the Painting Gallery as seen in FIG. 19. This screen provides the player the opportunity to view the most recent three paintings, and the associated creation information. The player will select “First,” “Second” or “Third” to display the related painting. The Gallery can display more than 3 paintings. The user can show/hide information about the painting by clicking the “Info” button while viewing the painting. The user can return to the Meditation menu by clicking the “Back” button as seen in FIG. 19.

### Poetry Mini-Game and Word Art Mini-Game

Another mini-game option is the “Poetry game” or “Word Art Game.” One started, the player is presented with a short poem, inspirational quote, phrase or stanza—or an option to insert his or her own text, by either keyboard entry or copy/paste functionality. Randomized and new initial word sets can be downloaded from the database. The player will then read the poem/text and initiate the game by having the game scramble the words. Words will be divided by the “space” character, and then jumbled into random order.

The player will be able to rearrange the words using standard touch-drag (or click-drag) interaction. In the Poetry variant of the game, the player will be asked to rearrange words into a new poem/phrase by re-ordering the words within the sequence. In the word-art variant, added functionality and control will allow the user to rotate and scale the words and place them in an artistic form. Additional features may include adding color to the words or background for added artistic effect. The word content and position will be saved and allow direct repeated recreation, or future modification.

### Butterfly Walk Augmented Reality Mini-Game

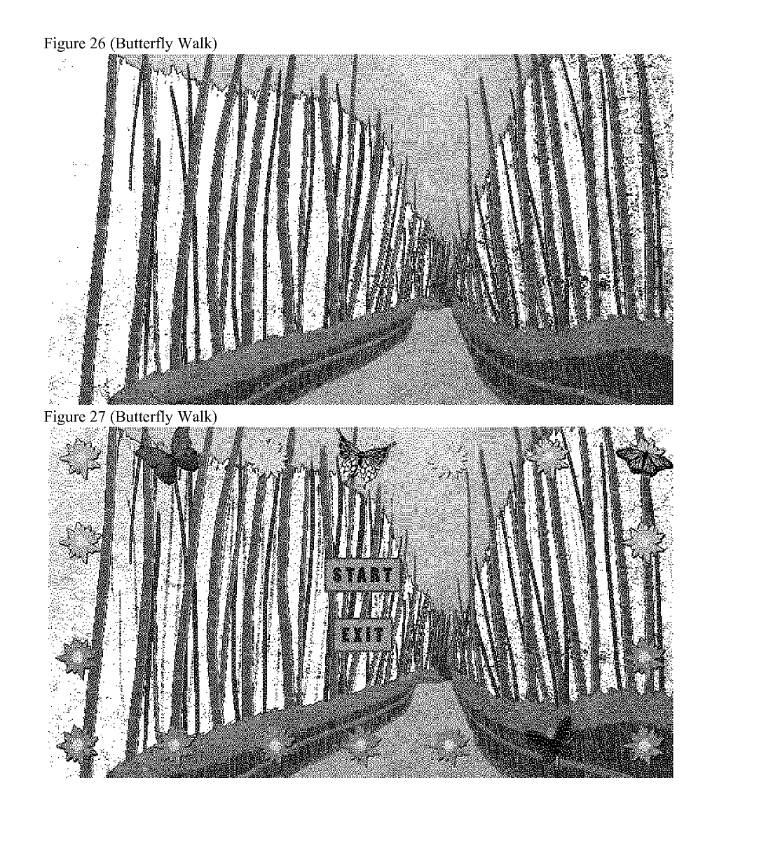

Another mini-game option is the “Butterfly Walk.” The “Butterfly walk will provide in incentive/feedback as an additional factor for the players exercise. The main screen is shown in FIG. 26. The user will initiate a “butterfly walk” either with a set or “free” time limit, and proceed to exercise. Exercise feedback from biosensors or on-device sensors will be evaluated to confirm actual movement/activity. In the course of the activity, awards will be given as affirmation of the user's achievement. These awards my take the shape of a butterfly animation displayed to the user as if they were exploring the wildlife of the surrounding area. The time and quality of the awards may vary based on random variables in addition to triggered algorithms.

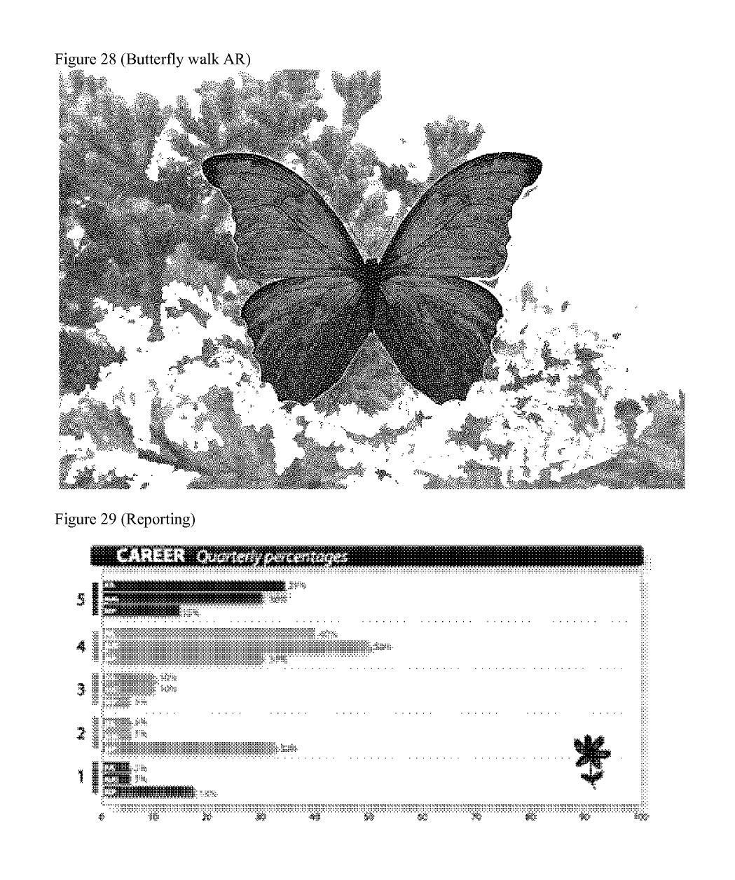

After the time limit is reached or the user selects “Stop” the award may be displayed as a standard animation or and Augmented Reality animation, using the player's device camera to superimpose the awards within the real world, and allow the player to capture an image of the awards as they exercise. Awards can also be based on location or rate at which the player is traveling. An example screenshot is shown in FIG. 28 of the awards screen. Once the player completes their exercise period, the images/awards can be viewed within the butterfly walk garden. The butterfly walk awards screen is shown in FIG. 27.

### Gratitude Mini-game

Another feature of the game system will be the “Gratitude Game.” This mini-game will be integrated into the application and supported with freestanding external applications. The player will be asked daily to enter at least one thing that they are grateful for, and also to describe the circumstances that have initiated this grateful feeling. The player will be able to add photos or documents from the device camera to the entry. The regular positive reminder of these focus items will provide positive mood reinforcement. Over time a library of theses items will be created and stored for future reference. This list can be presented by Date, or by title, and will have a search feature for finding specific items to review.

Gratitude entries can be shared via the social sharing function with other players, friends, or family, The Shared entry will have the functionality to have comments/responses made back to the player.

Players will also be able to create an archive or book of the items to allow for a physical reminder of their gratitude entries in the future.

### Social Sharing

The player will be able to share their achievements, awards, and entries within the application.

These achievements can be shared with a friends and family support application or in some cases with the approval of the player, to standard social media sites such as Twitter or Facebook.

The support application provided to friends and family will allow the peer/family support group to view the progress of the player individually, and provide feedback through the app back to the player. This integrated communication will allow the display of the meditation paintings, Fishing Paintings, Shrine upgrades, Word or Poetry art, butterflies, and much more. Standard feedback tracking based on the clinical questions may also be available.

### Fishing Mini-Game

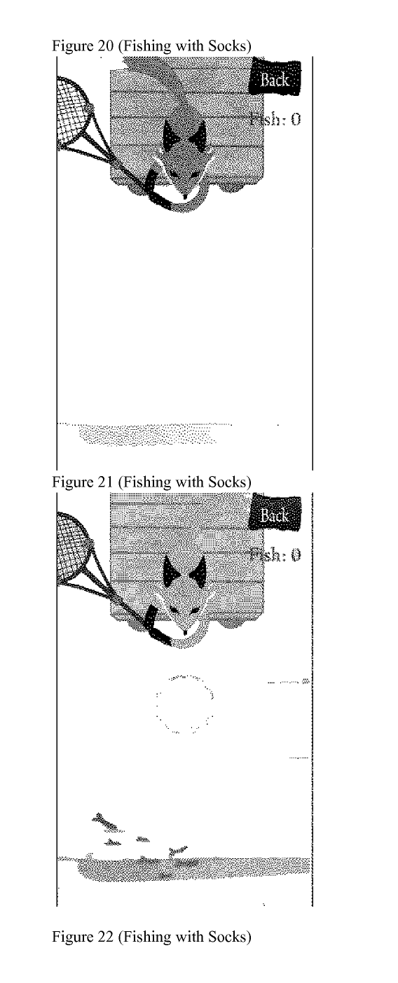

Another Mini-game option is “Painting Fish with Socks.” FIG. 20 is a screenshot presented to the player when this game is selected. In the game play of “Painting Fish with Socks,” the user can tap once on the screen and a ripple in the water will be generated as shown in FIG. 21. The player can then tap a second time to establish a rhythm. The ripples propagate out of the edge of the screen and then move in the opposite direction, radially inward and converging at the center. This is represented by FIG. 22. The game will also display a shadow of a fish at this point of the game. After several taps, shadows appear and they begin to become larger after a succession of several taps.

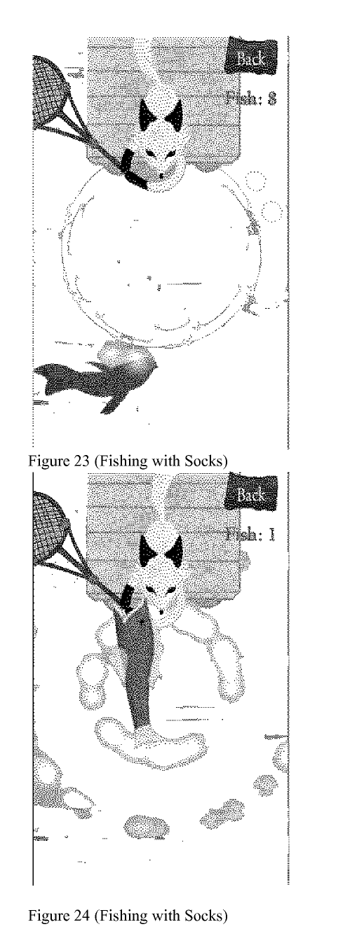

After the shadow appears as shown in FIG. 22, a fish bursts from the water as shown in FIG. 23. The user can use his/her finger on the screen to encircle the fish. The fish is then “painted” by the player. The stylized painting of the fish may be displayed momentarily to confirm the success of the actions. A gallery of the fish paintings can be displayed as the player continues to play the game.

In other embodiments, a player's accumulation of fish can be rewarded with additional panting equipment. There can also be multiple types of fish, of differing levels of rarity. FIG. 24 shows that in some embodiments the player can be presented with items other than fish. For example, a boot as shown in FIG. 24 can represent a missed fish.

### Shrine Enhancements

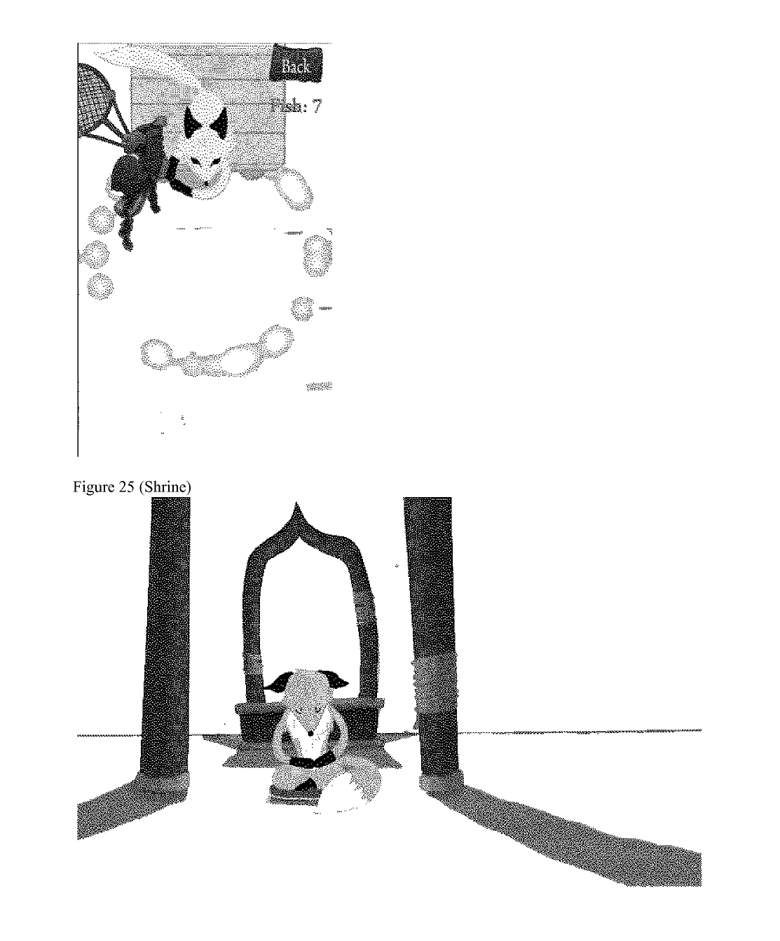

Another option for the user from the main screen in FIG. 1 is to “Visit the Shrine.” The fourth component is the player's own self-monitoring. The player can monitor his/her progress and the character's progress within the game play. The shrine, for example, allows the player to monitor progress. The shrine is shown in FIG. 1. In FIG. 1, as the player uses the “Journal of Clarity” the outside of the shrine will be built in stages. The user is directed to the screen shown in FIG. 25 when selecting this option. The shrine is simulated environment where the player's progress throughout use of the system over time, whether they are playing any of the modules, is tracked. The user is also reminded of the objective of the game; in the exemplary embodiment the objective is to accumulate tails for the character Socks. The user is advised of the number of tails they've earned as they've been using the system over time.

In another embodiment of the broader invention, there could be other aspects that are introduced such as virtual candles or the appearance of the shrine may change as the player progresses. For example, a tapestry or carpets may appear, or the shrine may fill with visually appealing items. Such items represent progress for the player. Upon exiting the shrine, the player is again presented with the main screen shown in FIG. 1.

### Overview

It is noted that the exemplary system can be viewed as including but not limited to four components. The first component is a therapeutic component. The Journal of Clarity described above serves the first component. There is also a second component of the exemplary embodiment which is the clinician communication throughout the exemplary system, which is exercised by a clinician or other health care provider accessing the date gathered through the Oracle of Truth. The questions posed to the user can be typical questions that clinicians or community health organizations could pose to the user directly. The third component, the mini-games are design to entertain the user and encourage other healthy activities. The fourth component is defined as “Sock's Shrine” and is an exemplary embodiment of player progression. For other chronic conditions, the component may be something else, but in general there is a player progression.

The target group for the exemplary embodiment is adult women. However, the exemplary embodiment can have resonance with all audiences. Embodiments of the invention can be varied to enhance effectiveness with respect to an age group, gender, race, or national origin. Embodiments of the invention can be applied not only for anxiety and depression, but for other chronic conditions as well.

Medication adherence could be reinforced with an embodiment of the invention. Diabetes management could also be assisted with an embodiment of the invention. The game play and animations could be changed in such embodiments. Asthma and heart disease are other diseases that could be addressed with alternative embodiments of the broader invention. At least some embodiments of the invention can apply cognitive behavioral therapy.

Embodiments of the invention can be executed on any kind of electronic computing device, including smart phones, desk-top and lap-top computers, e-readers, and tablets.

In some embodiments, a player could be represented by an avatar and the animations can be executed using the avatar. Some embodiments may allow the user to customize characters, such as the fox associated with the exemplary embodiment. In some embodiments, the avatar or character may be modified or may change over time. For example, a character may start as a baby and change to an adolescent state.

It is noted that the system can be designed such that the options available to the user are limited under some circumstances. For example, the availability of one or more of the games might be withheld until the user completes the weekly check-in. In addition or alternatively, the user may be required to complete the relaxation sub-routine before the weekly check-in or the games.

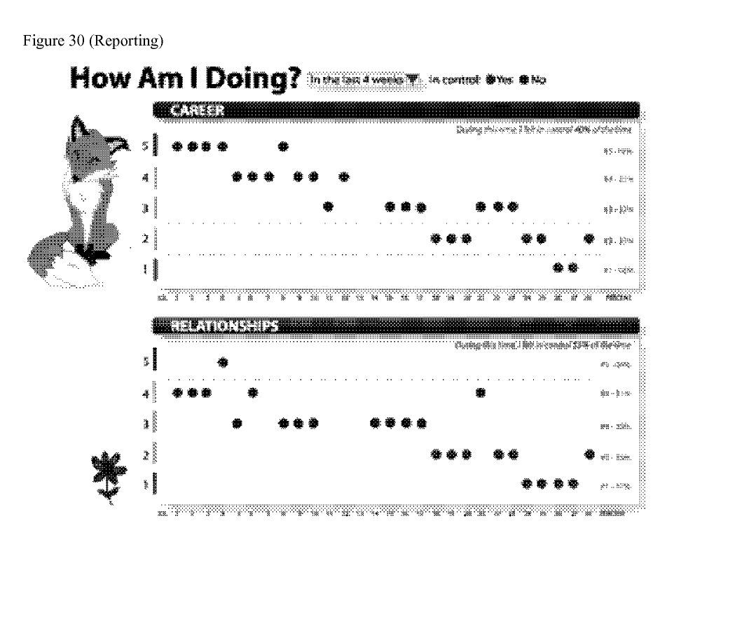

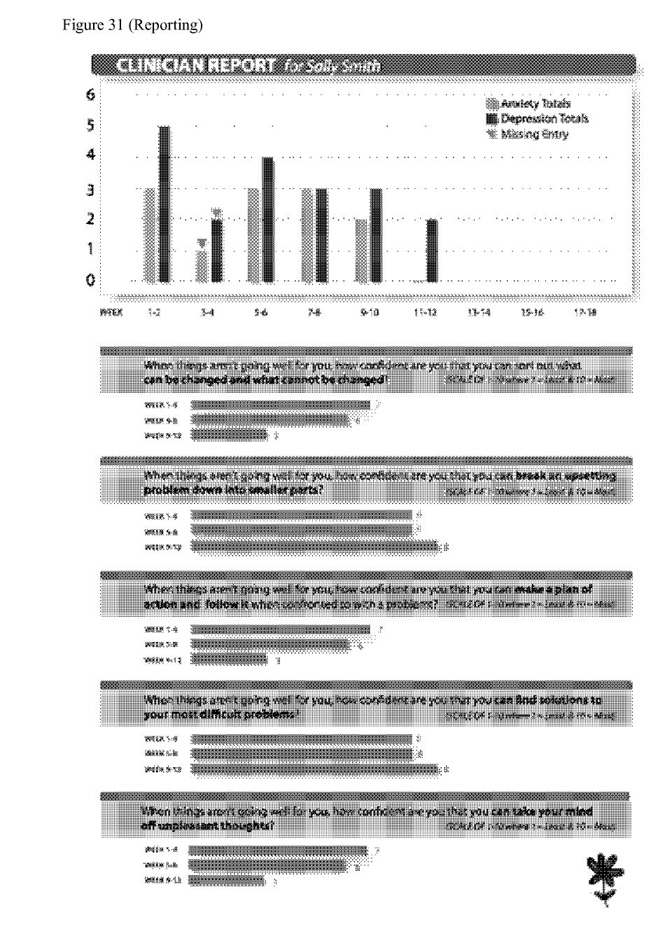

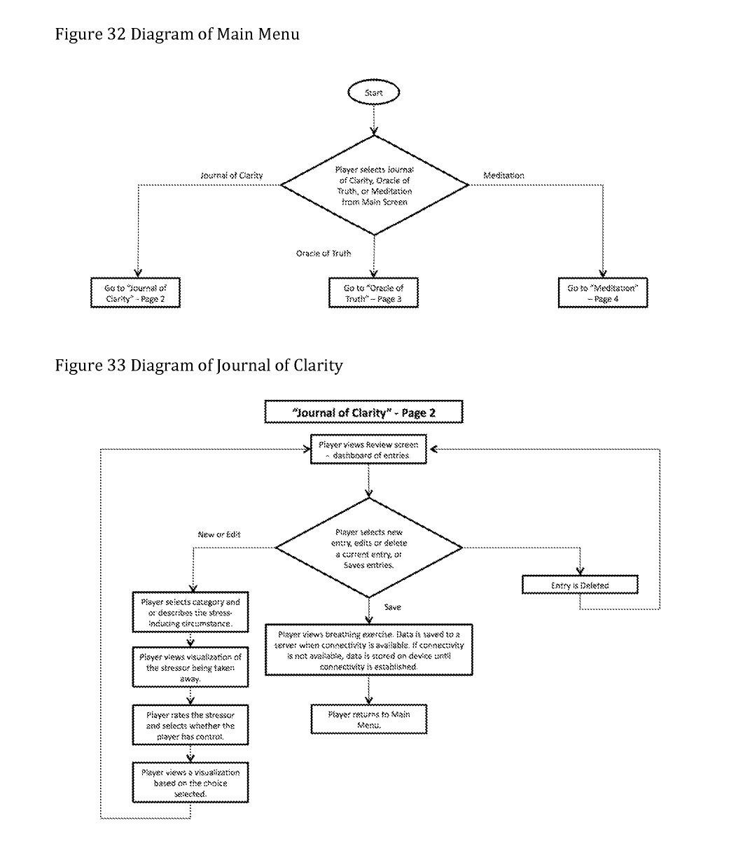

An embodiment of the system can include taking the data entered from the four modules, storing it in a database or providing it to one or more external applications, which are other software programs or electronic services, and displaying the information to the player or other parties, including clinician, patient authorized individuals, and other health organizations such as hospitals or community health organizations. The information can be anonymized. Progress reports may be a record or statements where portions of the record or statements may include functionality to provide predictive insights and/or recommendations based on algorithms, trends, data analysis, and user-generated data, data from phones tablets, personal computers, and data from biosensors, collected by the system. Progress reports may be generated which may also be available to the player or other parties, including clinicians, patient authorized individuals, and other health organizations such as hospitals or community health organizations. FIGS. 29-32 are examples of reports that may be generated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

### Steps for Shrine Progression:

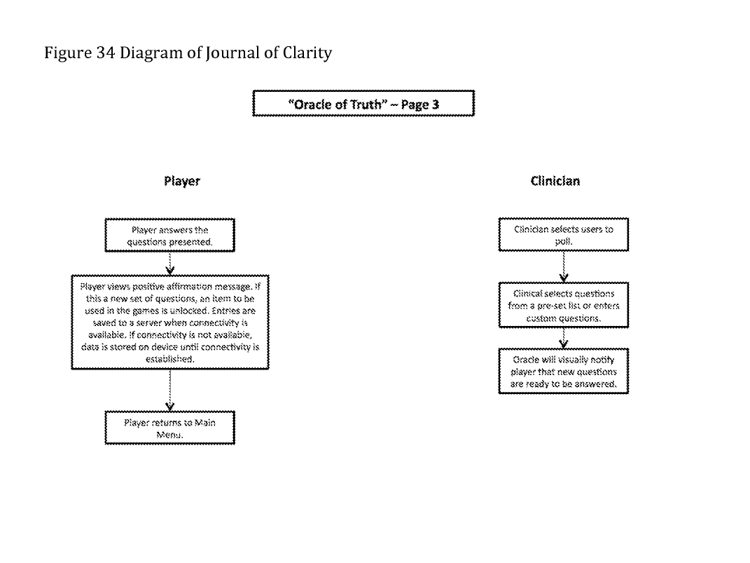

1. As the player completes the Journal of Clarity, a shrine builds on the Main Screen.
   FIG. 33 Illustrates the Steps for the Journal of Clarity, which May Include:
1. Player selects Journal of Clarity from main screen.
2. Player reviews dashboard of entries.
3. Player selects new entry, or selects current entry to edits or delete.
4. Player selects category and or describes the stress-inducing circumstance.
5. Player views visualization of the stressor being taken away.
6. Player rates and selects whether the player has control.
7. Player views a visualization based on the choice selected.
8. Player reviews dashboard of entries and edits entries again as necessary.
9. Player selects “Save and Breathe”
10. Player views breathing exercise. Data is saved to a server when connectivity is available. If connectivity is not available, data is stored on device until connectivity is established.
11. Player views Main Menu.
   FIG. 34 Illustrates the Steps for Oracle of Truth, which May Include:

### For the Player:

1. Player selects Oracle of Truth from the main screen.
2. Player answers the questions presented.
3. Player views positive affirmation message. If this a new set of questions, brushes are unlocked. Entries are saved to a server when connectivity is available. If connectivity is not available, data is stored on device until connectivity is established.
4. Player views Main Menu

### For the Clinician:

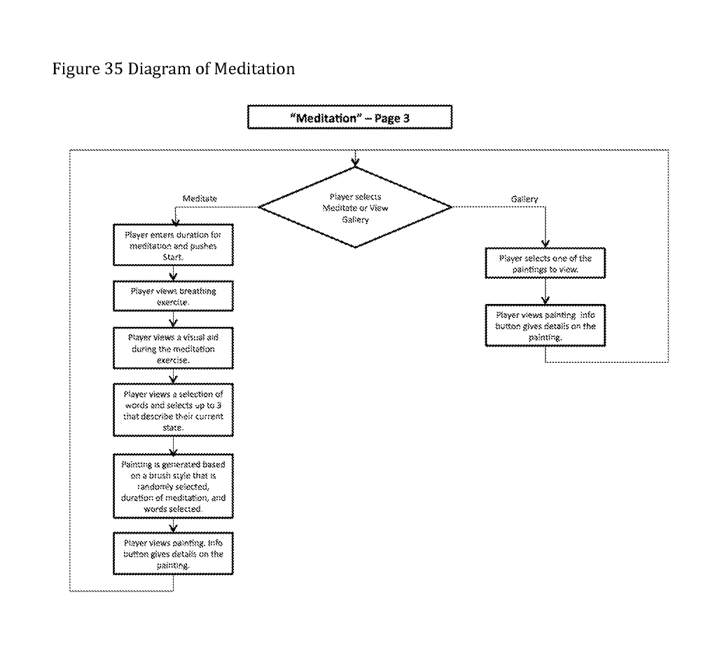

1. Clinician selects users to poll.
2. Clinical selects questions from a pre-set list or enters custom questions.
3. Oracle will visually notify player that new questions are ready to be answered.
   FIG. 35 Illustrates the Steps for Meditation, which May Include:
1. Player selects “Meditation” from the Main Menu.
2. Player enters duration for meditation and pushes Start.
3. Player views breathing exercise.
4. Player views a visual during the meditation exercise.
5. Player views a selection of words and selects up to 3 that describe their current state.
6. Painting is generated based on a brush style that is randomly selected, duration of meditation, and words selected.
7. Player views painting. Info button gives details on the painting.
8. Player returns to Meditation Screen where they can view the Gallery.

### Gallery

1. Player selects “Gallery” from the Meditation Menu.
2. Player selects painting to exhibit. Info button gives details on the painting.

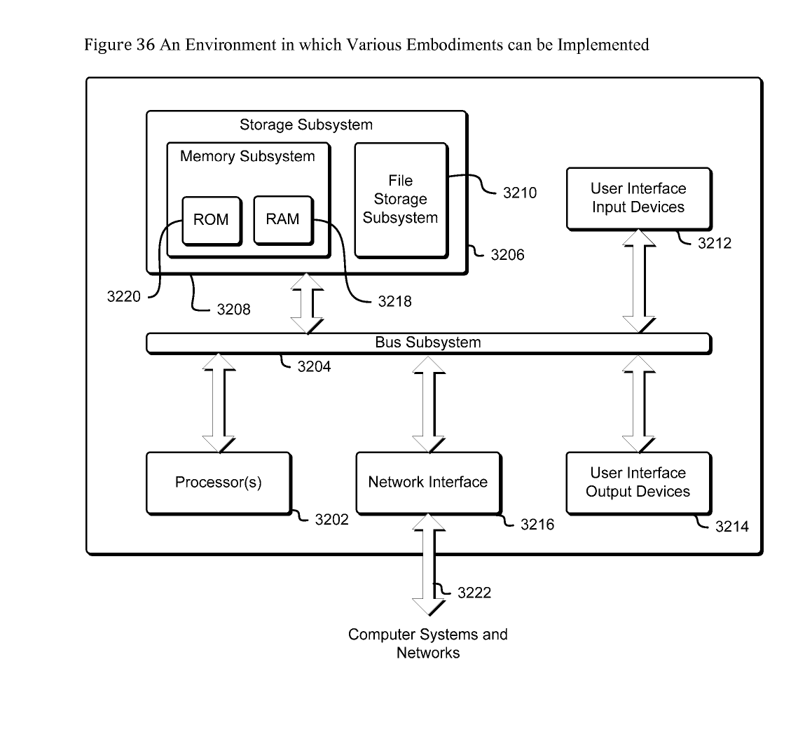

FIG. 36 is a simplified block diagram of a computer system that may be used to practice an embodiment of the present invention. In various embodiments, one or more instances of the computer system illustrated in FIG. 36 may be used to implement any of the systems illustrated and described above. For example, one or more instances of the computer system illustrated in FIG. 36 may be used to implement processes for executing the therapeutic modules according to the present disclosure. The computer system illustrated in FIG. 36 may include one or more processors 3202 that may be configured to communicate with and are operatively coupled to a number of peripheral subsystems via a bus subsystem 3204. These peripheral subsystems may include a storage subsystem 3206, comprising a memory subsystem 3208 and a file storage subsystem 3210, one or more user interface input devices 3212, user interface output devices 3214, and a network interface subsystem 3216.

The bus subsystem 3204 may provide a mechanism for enabling the various components and subsystems of computer system illustrated in FIG. 36 to communicate with each other as intended. Although the bus subsystem 3204 is shown schematically as a single bus, alternative embodiments of the bus subsystem may utilize multiple busses.

The network interface subsystem 3216 may provide an interface 3222 to other computer systems and networks. The network interface subsystem 3216 may serve as an interface for receiving data from and transmitting data to other systems from the computer system illustrated in FIG. 36. For example, the network interface subsystem 3216 may enable a user computer system device to connect to the computer system illustrated in FIG. 36 via the Internet and/or other network, such as a mobile network, and facilitate communications using the network(s) and to interact with the therapeutic modules.

The user interface input devices 3212 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. Further, in some embodiments, input devices may include devices usable to obtain information from other devices, such as external mobile devices. Input devices may include, for instance, magnetic or other card readers, one or more USB interfaces, near field communications (NFC) devices/interfaces and other devices/interfaces usable to obtain data (e.g., data related to progress towards one or more goals) from other devices. In general, use of the term “input device” is intended to include all possible types of devices and mechanisms for inputting information to the computer system illustrated in FIG. 36.

The user interface output devices 3214 may include a display subsystem, a printer, non-visual displays (e.g., audio and/or tactile output devices), or other such display devices. Generally, the output devices 3214 may invoke one or more of any of the five senses of a user. For example, the display subsystem may be a cathode ray tube (CRT), a flat-panel device, such as a liquid crystal display (LCD), light emitting diode (LED) display, or a projection or other display device. In general, use of the term “output device” is intended to include all possible types of devices and mechanisms for outputting information from the computer system illustrated in FIG. 36. The user interface output devices 3214 may be used, for example, to generate and/or present user interfaces to facilitate user interaction with applications performing processes described herein and variations therein, when such interaction may be appropriate. While a computer system illustrated in FIG. 36 with user interface output devices is used for the purpose of illustration, it should be noted that the computer system illustrated in FIG. 36 may operate without an output device, such as when the computer system illustrated in FIG. 36 is operated in a server rack and, during typical operation, an output device is not needed.

The storage subsystem 3206 may provide a computer-readable storage medium for storing the programming and data constructs that provide the functionality of the present invention. Software (programs, code modules, instructions) that, when executed by one or more processors 3202, may provide the functionality of the present invention, may be stored in storage subsystem 3206. The storage subsystem 3206 may also provide a repository for storing data used in accordance with the present invention. The storage subsystem 3206 may comprise memory subsystem 3208 and disk or file storage subsystem 3210. The storage subsystem may include database, file storage, and/or other storage functionality.

The memory subsystem 3208 may include a number of memory devices including, for example, random access memory (RAM) 3218 for storage of instructions and data during program execution and read-only memory (ROM) 3220 in which fixed instructions may be stored. The file storage subsystem 3210 may provide a non-transitory persistent (non-volatile) storage for program and data files, and may include a hard disk drive, a floppy disk drive along with associated removable media, a compact disk read-only memory (CD-ROM) drive, a digital versatile disk (DVD), an optical drive, removable media cartridges, and other like storage media.

The computer system illustrated in FIG. 36 may be of various types including a personal computer, a portable computer, a mobile device, a workstation, a network computer, a mainframe, a kiosk, a server, or any other data processing system. Due to the ever-changing nature of computers and networks, the description of computer system illustrated in FIG. 36 is intended only as a specific example for purposes of illustrating the preferred embodiment of the computer system. Many other configurations having more or fewer components than the system illustrated in FIG. 36 are possible.

The various embodiments further can be implemented in a wide variety of operating environments, which in some cases can include one or more user computers, computing devices or processing devices which can be used to operate any of a number of applications. User or client devices may include any of a number of general purpose personal computers, such as desktop, laptop or tablet computers running a standard operating system, as well as cellular, wireless and handheld devices running mobile software and capable of supporting a number of networking and messaging protocols. Such a system may also include a number of workstations running any of a variety of commercially-available operating systems and other known applications for purposes such as development and database management. These devices may also include other electronic devices, such as dummy terminals, thin-clients, gaming systems and other devices capable of communicating via a network. These devices may also include virtual devices such as virtual machines, hypervisors and other virtual devices capable of communicating via a network.

The various embodiments of the present disclosure may utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, or any combination thereof.

In embodiments utilizing a web server, the web server may run any of a variety of server or mid-tier applications, including Hypertext Transfer Protocol (“HTTP”) servers, Hypertext Transfer Protocol Secure (“HTTPS”) servers, Transport Layer Security (“TLS”) servers, File Transfer Protocol (“FTP”) servers, Common Gateway Interface (“CGI”) servers, data servers, Java servers, Apache servers, Internet Information Services (“IIS”) servers, proxy servers (e.g., F5®, Squid, etc.), business application servers, and/or other such servers. The server(s) may also be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python®, JavaScript®, or TCL, as well as combinations thereof. The server(s) may also include database servers, including without limitation those commercially available from Oracle®, Microsoft®, Sybase®, and IBM® as well as open-source servers such as MySQL, Postgres, SQLite, NoSQL, Hadoop, MongoDB, or other servers capable of storing, retrieving, and accessing structured or unstructured data. Database servers may include table-based servers, document-based servers, unstructured servers, relational servers, non-relational servers or combinations of these and/or other database servers.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such storage devices may also include a computer-readable storage media reader, a communications device (e.g., a modem, a network card (wireless or wired), or an infrared communication device), and working memory as described above. The computer-readable storage media reader may be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as, but not limited to, volatile and non-volatile, removable and non-removable media implemented in any method or technology for storage and/or transmission of information such as computer-readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory (referred to herein as a “non-transitory computer-readable storage medium”), may be tangible (referred to herein as a “tangible computer-readable storage medium”), or may be both tangible and non-transitory (referred to herein as a “tangible non-transitory computer-readable storage medium”).

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for treating one or more related conditions associated with a chronic medical condition, comprising:
under the control of one or more computer systems configured with executable instructions,
selecting one or more stress-inducing circumstances associated with the one or more related conditions, the one or more stress-inducing circumstances selected from a set of stress-inducing circumstances, the set of stress-inducing circumstances based at least in part on the chronic medical condition;
configuring an avatar with a set of behaviors based at least in part on the one or more related conditions;
configuring the avatar with a set of goals based at least in part on the one or more stress-inducing circumstances;
presenting a therapeutic module configured to teach one or more chronic condition management skills using one or more behaviors of the set of behaviors of the avatar, the one or more chronic condition management skills based at least in part on the one or more stress-inducing circumstances;
presenting a query module configured to provide a set of questions using the avatar, the set of questions based at least in part on the one or more stress-inducing circumstances associated with the chronic condition, the set of questions further based at least in part on one or more goals of the set of goals of the avatar;
presenting an activity module configured to provide one or more activities using the avatar, the one or more activities selected from a set of activities based at least in part on the chronic medical condition, the one or more activities specifying one or more activity metrics associated with the chronic medical condition, the one or activity metrics configured based at least in part on one or more responses to the set of questions;
presenting a progression module configured to measure one or more progression metrics using the avatar, the one or more progression metrics based at least in part on the one or more activity metrics; and
providing a progress report, the progress report based at least in part on one or more of the one or more chronic condition management skills.

2. The computer-implemented method of claim 1, wherein the one or more stress-inducing circumstances are selected based at least in part on a treatment plan received from a medical practitioner associated with the treatment of the chronic medical condition.

3. The computer-implemented method of claim 1, wherein the one or more stress-inducing circumstances are selected from the set of stress-inducing circumstances by a patient suffering from the chronic medical condition.

4. The computer-implemented method of claim 1, wherein the progression module is further configured to:
add one or more behaviors to the set of behaviors based at least in part on the one or more activity metrics;
add one or more goals to the set of goals based at least in part on the one or more activity metrics; and
add one or more activities to the set of activities.

5. The computer-implemented method of claim 1, wherein the progression module is further configured to track a progression goal using the avatar, the progression goal based at least in part on the one or more psychological conditions, the progression goal further based at least in part on the set of goals.

6. A system, comprising:
at least one computing device configured to implement one or more services, wherein the one or more services are configured to:
present a therapeutic module, the therapeutic module configured to teach one or more chronic condition management skills, the one or more chronic condition management skills based at least in part on one or more stress-inducing circumstances;
present a query module, the query module configured to provide a set of questions, the set of questions based at least in part on the one or more stress-inducing circumstances;
present an activity module, the activity module configured to provide one or more activities, the one or more activities selected from a set of activities based at least in part on the one or more chronic condition management skills, the one or activities configured based at least in part on one or more responses to the set of questions;
present a progression module, the progression module configured to measure one or more progression metrics associated with a user of the system, the one or more progression metrics selected from a set of progression metrics based at least in part on the one or more activities; and
provide a progress report, the progress report based at least in part on one or more of the one or more chronic condition management skills.

7. The computing system of claim 6, wherein one or more of the one or more stress-inducing circumstances are based at least in part on a chronic medical condition.

8. The computing system of claim 6, wherein the one or more services are further configured to instantiate an avatar, the avatar comprising a visual representation, the avatar configured with a set of behaviors based at least in part on one or more psychological conditions associated with the chronic condition, the avatar further configured with a set of goals based at least in part on the one or more stress-inducing circumstances.

9. The computing system of claim 8, wherein the therapeutic module is further configured to teach the one or more chronic condition management skills using the avatar.

10. The computing system of claim 8, wherein the query module is further configured to provide a subset of the set of questions using the avatar, the subset selected based at least in part on the set of goals.

11. The computing system of claim 8, wherein the activity module is further configured to provide the one or more activities using the avatar, the one or more activities selected from the set of activities based at least in part on the set of behaviors.

12. The computing system of claim 8, wherein the progression module is further configured to measure the one or more progression metrics using the avatar, the one or more progression metrics selected from the set of progression metrics based at least in part on the set of goals.

13. The computing system of claim 6, wherein the one or more activities include one or more mini-games.

14. A tangible non-transitory computer-readable storage medium having stored thereon executable instructions that, when executed by one or more processors of a computer system, cause the computer system to at least:
instantiate an avatar comprising:
a visual representation;
one or more behaviors based at least in part on one or more related conditions associated with a chronic condition;
one or more goals based at least in part on one or more stress-inducing circumstances associated with the one or more related conditions;
teach one or more chronic condition management skills using the one or more behaviors of the avatar, the one or more chronic condition management skills selected from a set of chronic condition management skills based at least in part on the one or more stress-inducing circumstances;
ask one or more questions using the avatar, the one or more questions based at least in part on the one or more stress-inducing circumstances, the one or more questions further based at least in part on the one or more goals of the avatar;
present one or more activities using the avatar, the one or more activities selected from a set of activities based at least in part on the chronic condition, the one or more activities specifying one or more activity metrics associated with the chronic condition, the one or activity metrics configured based at least in part on one or more responses to the one or more questions; and
track a progression goal associated with a patient suffering from the chronic condition using the avatar, the progression goal based at least in part on the one or more related conditions, the progression goal further based at least in part on the one or more goals of the avatar.

15. The tangible non-transitory computer-readable storage medium of claim 14, wherein the visual representation of the avatar is based at least in part on one or more preferences specified by a patient suffering from the chronic condition.

16. The tangible non-transitory computer-readable storage medium of claim 14, wherein the one or more activities include one or more mini-games.

17. The tangible non-transitory computer-readable storage medium of claim 16, wherein the one or more mini-games include at least one of: a meditation mini-game, a poetry mini-game, a word art mini-game, an augmented reality mini-game, a butterfly walk mini-game, a fishing mini-game, or a gratitude mini-game.

18. The tangible non-transitory computer-readable storage medium of claim 14, wherein the executable instructions that cause the computer system to track the progression goal further include executable instructions that cause the computer system to provide one or more progress reports associated with the progression goal to one or more external applications.

19. The tangible non-transitory computer-readable storage medium of claim 14, wherein the one or more stress-inducing circumstances are selected from a set of stress-inducing circumstances associated with the one or more related conditions by a patient suffering from the chronic condition.

20. The tangible non-transitory computer-readable storage medium of claim 14, wherein:
the one or more activities include one or more meditation activities; and
the progression goal is based at least in part on the one or more meditation activities.
